(19) United States
(12) Patent Application Publication
(10) Pub. No.: US 2011/0120284 A1
(43) Pub. Date: May 26, 2011

(54) NECK BRACE AND OCTAVE KEY

(76) Inventor: Allen Theodore WANNE, Bellingham, WA (US)

(21) Appl. No.: 12/625,054

(22) Filed: Nov. 24, 2009

(51) Int. Cl. G10D 7/08

(52) U.S. Cl. 84/385 R

(57) ABSTRACT

A novel neck for a musical instrument with a bent neck includes an elongated brace contacting a neck tube only at two points. An octave key is also provided for the neck. The octave key is pivotably supported on the brace and contacts the neck tube only at one point. The neck is designed to reduce the dampening effect of a brace and octave key by providing only a small contact surface area on the neck tube.

### RELATED APPLICATIONS

None

### BACKGROUND OF THE INVENTION

A. Field of Invention

The present invention pertains to an improved neck for a saxophone, and other similar musical instruments.

B. Description of the Prior Art

Woodwind instruments generally are known to have a main body defining a column of air. As is well known in the art, sound waves are produced within the column of air and the musical characteristics of the sounds, including pitch, volume and other characteristics, are modulated by changing the acoustic characteristics of the column. Keys are provided on the main body for playing various notes.

A neck is attached to the top of the main body. The neck includes a curved hollow tube made of a metallic material on which additional elements are mounted, such as a brace and an octave key. A mouthpiece with a reed is attached to one end of the tube. The other end of the tube, usually called the neck tenon is shaped and sized so that it can be telescopically inserted into the main body of the instrument.

When a musician blows through the mouthpiece, the reed oscillates and produces vibrations, which are then propagated through the cavity, in the mouthpiece into the tube of the neck, and then through the instrument body. Importantly, any significant mass contacting the tube of the neck interferes with the neck's ability to propagate the reed vibrations to the instrument body efficiently.

Typically, the neck of the instrument is often bent in order for the instrument's mouthpiece to be placed at a convenient location for use by the musician. Because the neck is bent already, it is prone to deflection and deformation. For this reason, the neck is provided with the neck brace discussed above that holds the neck in its correct position and reduces deflection and deformation of the neck. This brace is typically soldered to the outer surface of the tube and contacts a significant portion of this outer surface. While the brace strengthens the neck, it has been shown that the brace also dampens the vibration of the neck tube and hence it reduces its efficiency and results in a deadening in the sound of the instrument.

Finally, most neck instruments have an octave key attached to the neck tube. This key is used to selectively open or close a vent in the neck. The vent is arranged and constructed to allow the musician to play high notes in the range of the saxophone by manipulating the octave key. This octave key is also attached directly to the neck tube causing a further dampening of the vibration of the neck.

### SUMMARY OF THE INVENTION

A musical instrument constructed in accordance with this invention includes a neck brace that is set off from a vibrating neck tube and an octave key isolated from the neck tube and attached directly to the neck brace. One end of the neck brace is attached to the solid neck tenon and the other end contacts the neck collar of the neck tube. This allows the neck tube to vibrate freely and more resonantly than any prior neck brace and octave key attachment.

The neck brace includes two saddle shaped support projections attached to said neck tenon and said neck collar. The octave key includes a rocker lever which is attached to said support projections and an octave key button which covers the octave pip. Preferably, the surface of contact between the neck brace and the underside of the neck tube is a very small area.

Preferably the rocker lever is shaped to be captured between the two support projections but offset from the neck tube.

Preferably, the neck brace is shaped to be fitted longitudinally over the neck tube with said brace offset from the neck tube.

### BRIEF DESCRIPTION OF THE FIGURES

FIG. 1 shows a side elevational view of a typical saxophone neck tube without a neck brace or octave key;

FIG. 2 shows a side elevational view of the saxophone neck tube of FIG. 1 with a neck brace and an octave key;

FIG. 3 shows an orthogonal view of another known prior art alto saxophone neck;

FIG. 4 shows a side elevational view of a neck constructed in accordance with this invention;

FIG. 5 shows an orthogonal view of the neck of FIG. 4; and

FIG. 6 shows a bottom view of the neck of FIGS. 4 and 5 and constructed in accordance with this invention.

### DETAILED DESCRIPTION OF THE INVENTION

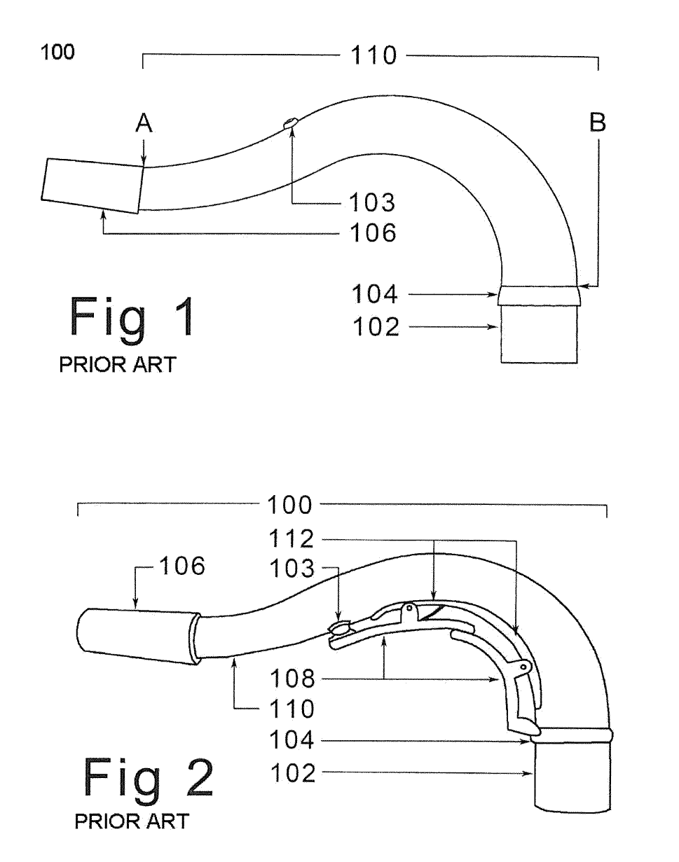

FIG. 1 shows a portion of a typical prior art neck 100 for an alto saxophone (not shown), it being understood that the invention may be used for other instruments as well. The neck 100 consists of a neck tube 110 having at one end a neck cork 106 that is used to mount a mouthpiece (not shown). A neck tenon 102 is disposed at the other end of the neck tube 110 and is used to attach the neck 100 to the main body of the saxophone. More specifically, the main body includes an elongated tubular body (not shown) having an opening at one end. The neck tenon 102 is telescopically inserted into this opening (not shown). The neck tenon 102 is delimited by an annular stop or neck collar 104.

Neck tube 110 is also provided with an octave pip 103 consisting of a vent hole in neck tube 110.

As shown in FIG. 2, the neck 100 further includes a brace 112 for strengthening tube 110, and prevent it from deformation while the instrument is being played. The neck 100 is also typically provided with an octave key 108 that can be selectively used to selectively open and close the octave pip 103, as discussed above. Both the brace 112 and the octave key 108 extend over and are in intimate contact with a substantial portion of the outer surface of tube 110 and therefore their mass causes a significant dampening of the natural resonance of the tube 110. In other words, a dampening of the vibration of the neck tube 110 results from the brace and the octave key.

The octave key 108 is also provided and it consists of a button 108 that covers octave pip 103 and an octave key lever 108A is fastened either directly to the neck tube 110 or indirectly to the neck tube 110 through neck brace 112.

As can be seen in FIG. 2, this octave key also dampens the resonance of neck 100 in fact. While other saxophones have necks with braces with other shapes, all of them, to the inventor's knowledge, contact and come in intimate contact with a large portion of the outer surface area of the neck tube and therefore they all dampen its resonance. For example, FIG. 3 shows another prior art example of a neck 114 for an alto saxophone. This neck 114 has a similar structure and operates the same way as neck 100 in FIGS. 1 and 2. The neck 114 includes a neck tube 110 with a neck cork 106 for holding a mouthpiece (not shown), and a neck tenon 102. A neck brace 118 serves the same strengthening purpose as neck brace 112 on prior art neck 100. An octave key 116 is attached to the neck pivot 117 which is in-turn soldered or glued on neck tube 110. Octave key 116 includes octave key button 116A that selectively covers octave pip 103. As seen in FIG. 3, in this case, the octave key lever 116 wraps around the neck 114 and has a fairly convoluted shape that is different to manufacturer and it is subject to damage or warping while the instrument is played, or is being taken out of, or returned to its storage box. Moreover, once again, since both the neck brace 118 and octave key 116 (via pivot 117) are fastened directly to the neck tube 110, the resonance of the neck tube 110 is dampened by these members.

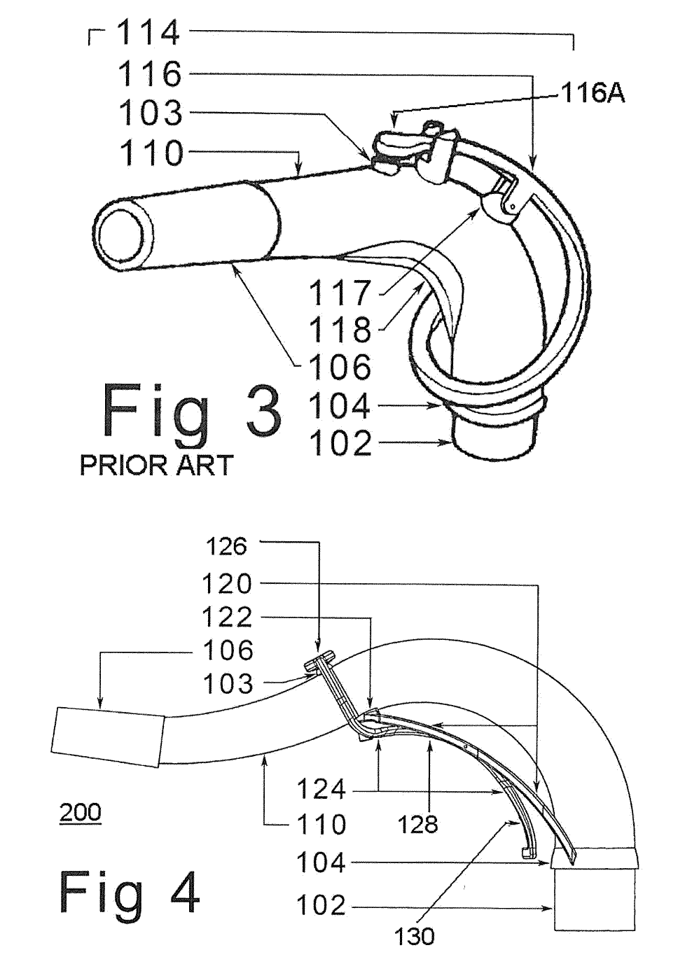

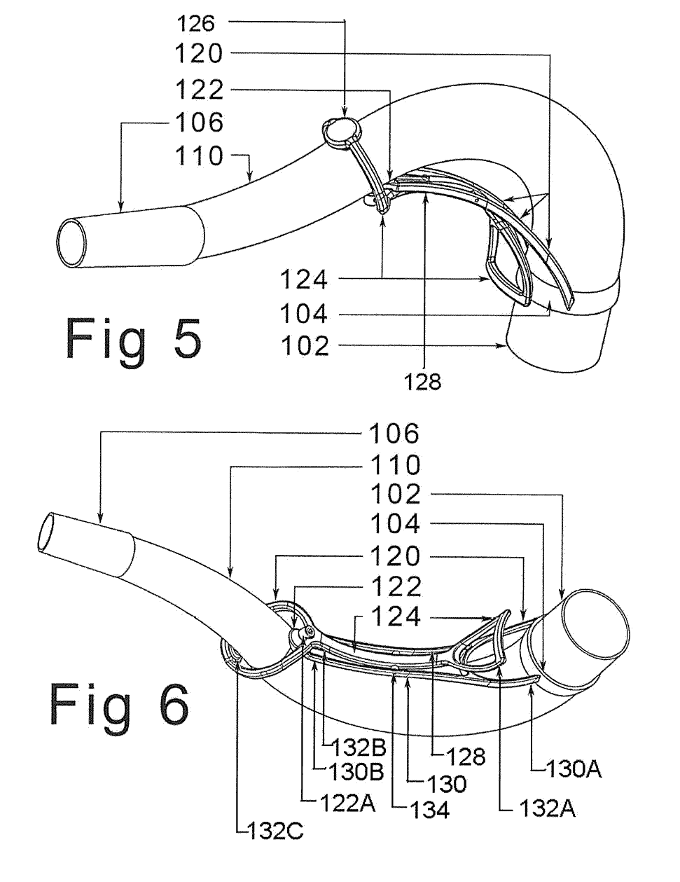

The present invention provides a novel neck 200 having a different and unique structure. The neck is shown in FIGS. 4-6. FIG. 4 shows a side elevational view of neck 200, having a conventional tube 110, neck cork 106, neck tenon 102, collar 104 and octave pip 103 and other features and elements essentially identical to the ones shown in FIGS. 1 and 2. As shown in FIGS. 4-6, neck 200 further includes neck brace 120 and an octave key 124. Neck brace 120 has a generally H-shape and is formed of two longitudinal or elongated members 128, 130. The lower ends of these members 128A, 130A are attached to the collar 104. The opposite ends 128B, 130B are attached to a boss 122. As can be seen from the figures, and especially FIG. 4, the brace 120 is preferably somewhat arcuate in shape (although it could be straight as well) but its radius of curvature is much larger then the radius of the tube 110 especially between the two points where brace 120 is attached to the tube 110, e.g., collar 104 and boss 122. In this manner the brace 120 acts as a strut to strengthen the tube 110 and prevent its distortion and collapse. Preferably the brace 120 is made of brass and is attached to the collar 104 and boss 122 by silver-soldering, with an appropriate adhesive or other well known means. Preferably boss 122 is made of brass.

The two members 128, 130 are joined at their midsection by a pivot screw 134 that is used to pivotably mount the octave key 124. Once joined, the two members and the pivot screw can be described as being formed of two saddle-shaped projections, one extending toward the mouthpiece, and the other extending toward the collar. The two projections are not identical. The projection extending toward the mouthpiece has two arms that approach each other while the saddle projection toward the collar has arms that extend away from each other. Both brace 120 and octave key 124 would be made of brass, however, many differing materials such as stainless steel, aluminum, and dense plastics could be used.

The octave key 124 includes a rocker lever 132 pivotably supported on the brace 110 by pivot screw 134. Preferably the octave key 124 is disposed between the 128, 130 so that it is normally protected. The octave key 124 has a cantilevered end 124A disposed near the collar 104. The other end of octave key 124 is terminated with a ring 124D that has a diameter larger then tube 120 and surrounds the tube as shown. Attached to this ring 124D there is a button 126. The octave key 124 is sized and constructed so that normally, the button 126 is disposed over and covers the octave pip 103. However, the player can push 124A to cause the octave key 124 to pivot clockwise around pivot screw 134 thereby causing the button 126 to lift off from the pip 103. Spring 132 is attached to octave key 124 and presses against boss 122 to assist in keeping button 126 pressed against octave pip 103. However, the player can push in 124A to cause the octave key 124 to pivot clockwise around pivot screw 134 thereby causing the button 126 to lift off from the pip 103. The key stops moving when the

adjustable stop 1246 attached to octave key 124 comes in contact with the boss 122. Adjustable stop 124B contains a set-screw 124C which adjusts the distance octave key 124 may travel before hitting boss 122.

As is well known in the art, this action causes the instrument to change pitch. When released, the key pivots counterclockwise back to its original position to cause button 126 to close the octave pip 103. Like the brace 120, the octave key 120 is made of generally straight narrow elements with large cutout and openings there-between, This insures that both members are light, cheaper to manufacture then standard prior art members.

Thus, in the prior art, the brace and the octave key both include members that are attached to a sizeable portion of the tube 110 thereby deteriorating the performance of the neck by damping the resonance of the tube 110.

In the present invention octave key 124 is not attached directly to tube 110 as it is instead attached to brace 120. Moreover, brace 120 is attached to tube 110 in only one spot of minimal surface area through boss 122. The other ends of brace 120, 128A and 130A, are attached to collar 104 and do not dampen tube 110. A variation of this invention would be for boss 122 and octave pip 103 to be formed as one piece to further reduce contact with tube 110.

The contact area between the combination of brace 120 and octave key 124 are much smaller then the areas of contact on the prior art necks disclosed above. This allows for less dampening of tube 110 and for an octave key made of less material since it does not need a mount to attach to the tube 110 such as is seen in prior art pivot 117. In this manner the present invention not only provides a brace and octave key that are light but also have only minimal number of contact points. Moreover the contact areas at these contact points are minimized. The brace 120 and octave key 124 of the present invention are much lighter and do not interfere with the vibration of tube 110 since they have less actual contact with the tube.

To summarize, the novel brace 120 has a number of advantages over the prior art neck brace. Since the brace has such minimal contact area with the neck tube, contacting it in only one place, the neck tube is very free to resonate with minimal dampening caused by the brace Further, because the octave key is completely isolated from the neck tube, the neck tube may vibrate free of the dampening affects caused by the octave key being mounted directly to the neck tube as has been done in the prior art. Also, since the octave key is mounted to the brace, no additional hardware is needed to mount it to the neck as is required by prior art keys allowing for a lighter mechanism.

Numerous modifications may be made to this invention without departing from its scope as defined in the appended claims. Such modifications may include moving the octave pip 103 to the underside of the neck as can been seen in FIG. 7. Even though the octave pip 103 has moved position, and the octave key 124 is split into two levers 124E and 124F, the octave key (124E and 124F) is still mounted entirely onto the neck brace 120 and hence still does not dampen neck tube 110. For this reason such a modification is still in accordance with the invention.

I claim:

1. A neck for a musical instrument comprising;
a curved tube having a first tube end receiving a mouthpiece, a second tube end for attaching said tube to the body of the musical instrument and an octave pip opening into the interior of the tube;
a brace having an elongated member having a first elongated member end attached to said tube at a first contact point and a second elongated member end attached to the tube at a second contact point, said brace being sized and shaped to strengthen said tube against distortions; and
an octave key having an elongated lever pivotably attached to said elongated member and having a first lever end and an octave button attached to said first lever end and arranged to constructed to selectively cover and uncover said octave pip when said lever is operated.

2. The neck of claim 1 wherein said octave key includes a ring disposed around said pipe, said ring being attached to said first lever end and supporting said octave button.

3. The neck of claim 1 wherein said brace includes a second elongated member with respective member ends attached to said tube near said first and second contact points respectively.

4. The neck of claim 3 wherein said brace further comprises a pivot screw extending in a central portion of said brace between said first and second elongated members, said lever being mounted rotatably on said pivot screw.

5. The neck of claim 1 wherein said tube has a tube radius of curvature between said first and second contact points and wherein said elongated member has an arcuate shape with a brace radius of curvature, said brace radius of curvature being substantially larger then said tube radius.

6. The neck of claim 1 wherein said brace further comprises a boss mounted on the outer surface of said tube, wherein said elongated member second end is attached to said boss.

7. The neck of claim 1 wherein said neck further includes a collar disposed near said second tube end, with said elongated member first end being attached to said second tube end.

8. The neck of claim 1 wherein said brace is made of brass.

9. The neck of claim 1 wherein said octave key is made of brass.

10. A neck for a musical instrument, said musical instrument including a body, a neck and a mouthpiece, comprising:
a brace having at least two generally saddle shaped projections having first and second ends attached to said tube at respective first and second contact points, said brace being sized and shaped to strengthen the tube against distortions; and
an octave key having a lever attached to said brace and octave button pivotable between a first position in which the button covers and closes an octave pip in the tube and a second position in which said pip is uncovered.

11. The neck of claim 10 wherein said lever is shaped to be captured between said saddle shaped projections.

12. The neck of claim 3 wherein said octave key is attached to said saddle shaped projections by a pivot screw.
